(19) United States
(12) Patent Application Publication
(10) Pub. No.: US 2015/0205304 A1
(43) Pub. Date: Jul. 23, 2015

(54) Flow Monitor and Regulator

(71) Applicant: Flometrix, Ames, IA (US)

(72) Inventors: Yuh-Yuan Shyy, Ames, IA (US); Manjit Misra, Ames, IA (US)

(21) Appl. No.: 14/577,224

(22) Filed: Dec. 19, 2014

Related U.S. Application Data
(60) Provisional application No. 61/918,433, filed on Dec. 19, 2013.

(51) Int. Cl. G05D 7/01

(52) U.S. Cl. CPC G05D 7/014

(57) ABSTRACT

The Application discloses an in-line, high capacity apparatus, system and method for measuring and regulating a flowable material, such as seed, grain or other material. The disclosed generally functions by measuring the pressure applied to a rounded cap by the flowing material. In certain alternative embodiments, the apparatus and method allow the user to regulate the flow rate.

### CROSS-REFERENCE TO RELATED APPLICATIONS

This application claims priority to U.S. Provisional Application No. 61/918,433 filed Dec. 19, 2013 and entitled “Flow Regulator,” which is incorporated herein by reference.

### TECHNICAL FIELD OF THE INVENTION

The embodiments disclosed herein relate to various agricultural and industrial device components and related components, including pressure sensing devices, flow meters, and other related components. More specifically, this invention relates to apparatus, systems and methods for monitoring and regulating the rate of flow of material that is passing through a pipe or flow meter under continuous flow conditions. Further embodiments relate to apparatus, systems and methods for operating the above components.

### BACKGROUND OF THE INVENTION

Monitoring and managing material flow through a passageway at different checkpoints in the passageway in real time for conditioning of grains or seeds, for example, can increase operating efficiency and can improve profitability.

Accurate flow measurement can result in improved process management and significant cost saving for companies handling high value products such as seeds and food grade materials, grain and feed handling, corn and soybean processing, popcorn, dry food ingredients, plastic pellets, and pharmaceuticals. Continuous monitoring of flow rates can also provide useful information for equipment adjustment or integrating with a process such as adding a chemical in seed treating or ingredients during food processing.

Current technologies generally require the impact of the seed or other flowable matter on the sensing device. There is a need in the art for an apparatus and method that achieves this result without measuring impact. There is further need in the art for a device which allows the control the rate of flow of the flowable material.

Exemplary embodiments of the flow meter measure the flow by way of pressure on a sensing cap, which can also be a displacement rather than impact. These embodiments of the flow meter allow the flow measurement of the material with less damage than that observed in the prior art, wherein the flow is obstructed by the impact on a surface or an impingement ring.

It is thus an object of the embodiments disclosed herein to provide a method of measuring the weight of a flowable material based on gravity or some other pressure or force. It is a further object to provide an apparatus for measuring the flow of such material. It is a further object to provide a means of regulating the flow of such material.

These and other objects will be apparent to those skilled in the art.

### BRIEF SUMMARY OF THE INVENTION

As discussed herein, the present invention relates to a method and apparatus for determining the weight of flowable material in unit time and the total weight during a time period of a material, particulate, slurry or liquid during conveyance with a sensing unit placed in the path of conveyance.

### DESCRIPTION OF THE DRAWINGS

FIG. 1A is a schematic view of the exterior of an exemplary embodiment of the flow meter.

FIG. 1B is an exploded view of the exterior of an exemplary embodiment of the flow meter.

FIG. 1C is a cutaway view of an exemplary embodiment of the flow meter.

FIG. 2A is an exploded view of another aspect of certain implementations of the flow meter and associated devices, systems and methods.

FIG. 2B is an exploded view of another aspect of an exemplary embodiment of the flow meter.

FIG. 2C is an exploded view of another aspect of an exemplary embodiment of the flow meter.

FIG. 3 is a cartoon schematic of another exemplary embodiment of the flow meter in operation.

FIG. 3A is a cross-sectional view of the housing and connector according to the embodiment in FIG. 3.

FIG. 4 is an exterior view of another exemplary embodiment of the flow meter.

FIG. 5 is a cutaway perspective view of another embodiment of the flow meter and associated devices, systems and methods.

FIG. 5A is a sideview perspective according to the exemplary embodiment of FIG. 5.

FIG. 6 is a side-view schematic of an embodiment of an alternative embodiment of the flow regulator depicting the regulator in series with the flow meter.

FIG. 7 is a top, cutaway view of the alternative embodiment of the flow regulation system featuring the frustoconical portion and overflow region.

FIG. 8 is a perspective cutaway view of the embodiment of FIG. 7.

### DETAILED DESCRIPTION

The present disclosure relates to apparatus, systems and methods for determining the rate of flow of a material, particulate, slurry or liquid during conveyance with a sensing unit placed in the path of conveyance such that the flow is measured without a loss in capacity of the conveyance. Exemplary embodiments may contain a flow sensing unit, an integrator and software directed to the interpretation of the data received by the sensing unit and integrator. Further embodiments comprise a flow regulation mechanism.

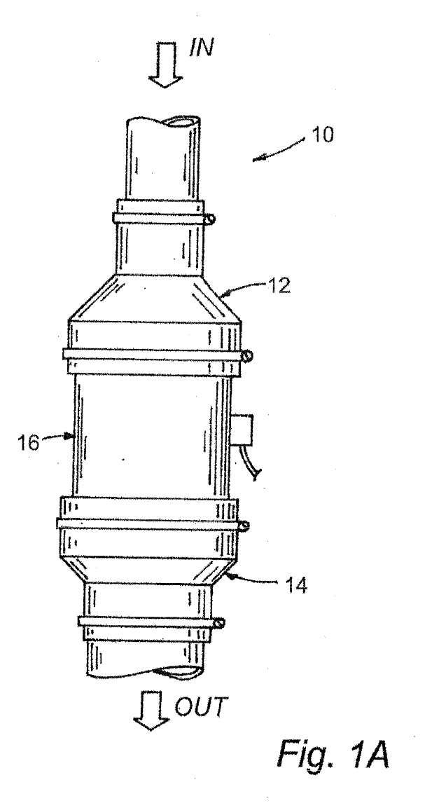

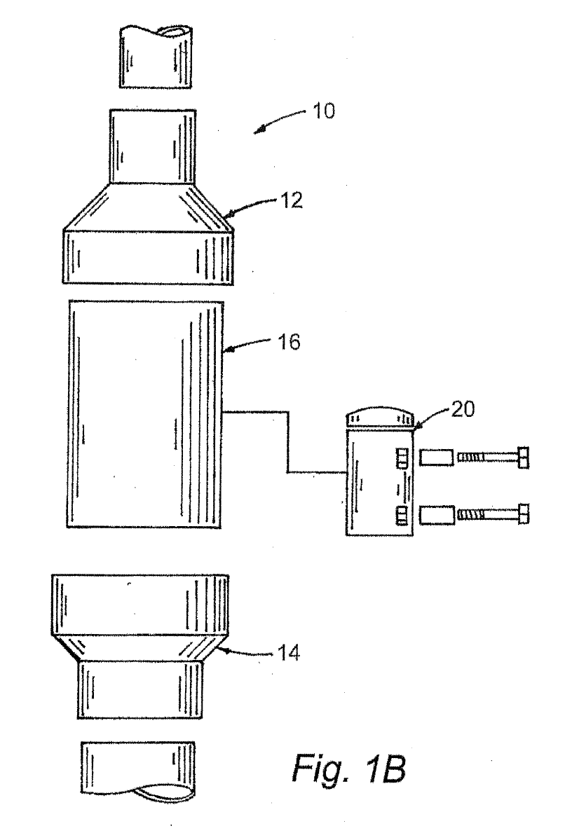

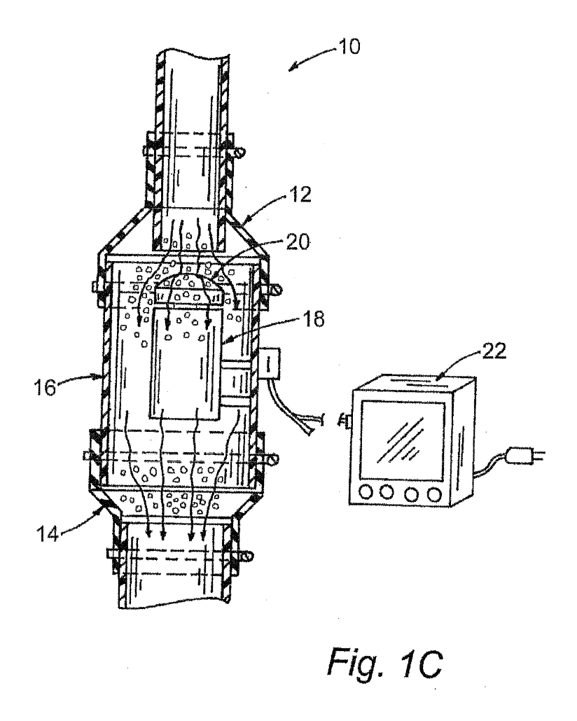

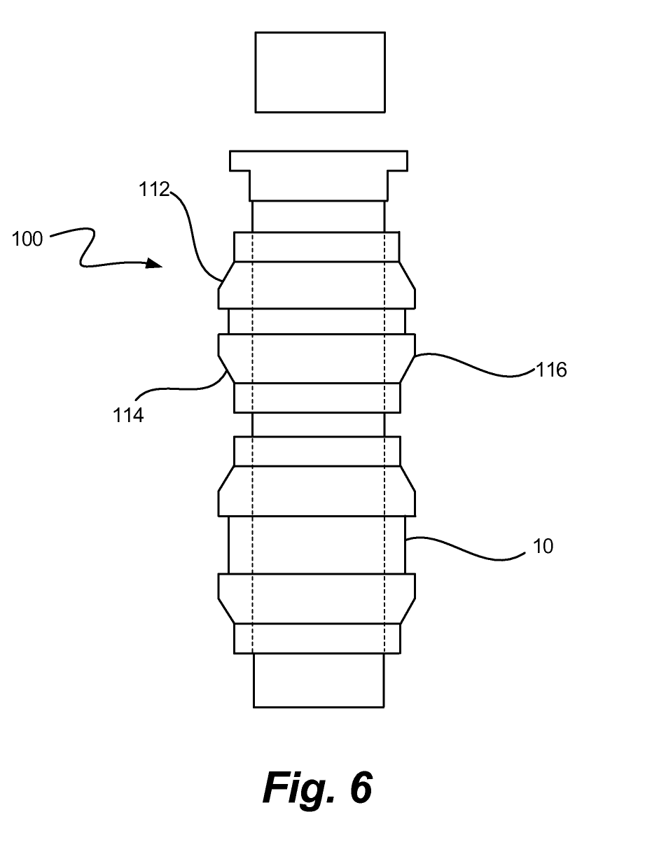

FIGS. 1A-5A generally show several exemplary embodiments of the flow meter, according to a first embodiment. FIGS. 6-8 depict views of a further embodiment of a flow regulator. It is understood that the various embodiments of flow meter disclosed herein can be incorporated into or used with any other known devices, systems and methods, including, but not limited to, the other flow meters and devices as defined herein.

As depicted in FIGS. 1A-1B, in certain embodiments the flow meter 10 consists of corresponding top 12 and bottom 14 beveled outer regions and an outer tube 16, along with an inner unit 18 topped by a sensing cap 20. As best shown in FIG. 1C, the inner unit 18 is then suspended within the outer tube 16. In certain embodiments, the inner unit 18 is topped by the sensing cap 20, and is operationally and communicatively connected to the PLC, HMI or other processing unit 22. These embodiments allow for high capacity throughput, as there is enough space between the inner and outer unit to maintain the capacity. Further, in certain embodiments, the flow meter allows for a reduction in the overall slowing effect caused by the impact of the flowable material on a measuring apparatus. This is achieved by measuring the overall displacement of the rounded cap relative to the inlet space, rather than measuring the impact as was done in the prior art. This is because the material in the present invention flows through a smaller inlet space above the cap, thereby merely changing the direction of the flow slightly, rather than causing impact. The rate of flow can thereby be measured by, in typical embodiments, measuring the pressure, or weight of the flowable material on the cap. Exemplary embodiments are thus able to measure both the weight of flowable material in unit time and the total throughput that has passed over the cap and through the flow meter. In certain embodiments, the sensing cap 20 has a slightly larger diameter than an inner unit 18, so as to prevent the accumulation of dust and debris in the opening between the cap and the unit.

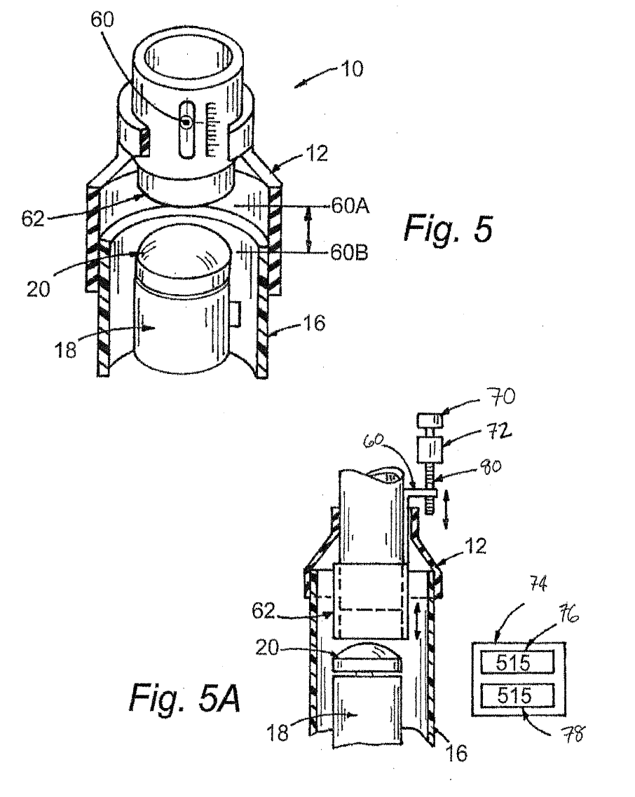

Other advantages of the flow meter over the prior art include the uniformity of the flow and the ability to regulate flow (as shown in part in FIGS. 5-8), particularly when the flowable material is being introduced to the system by way of a bucket elevator, or other means which introduces spikes or other variations in the typical flow speed.

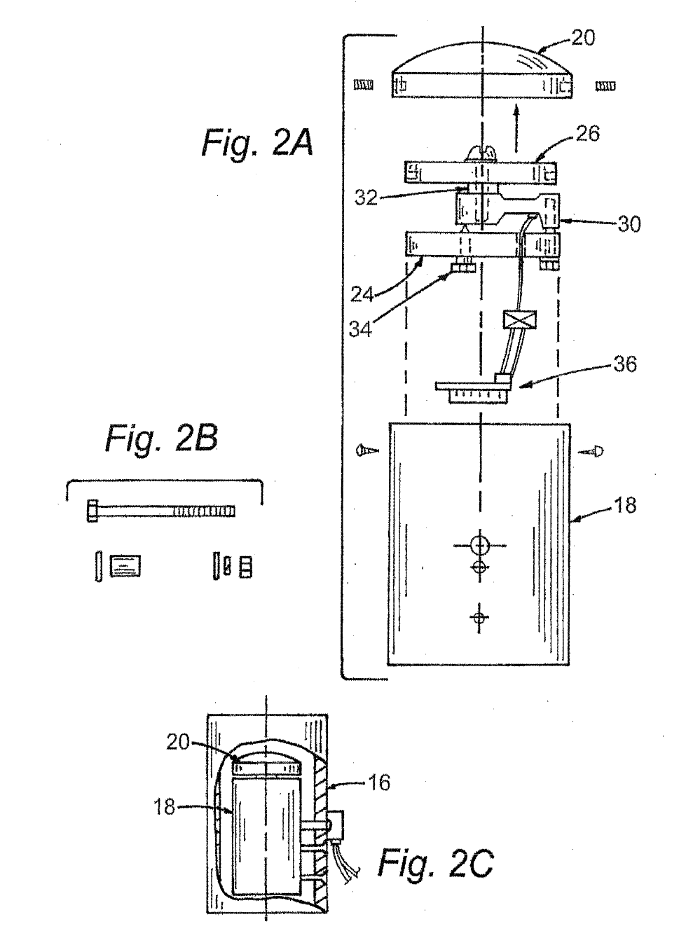

As best shown in FIGS. 2A-2C, in some embodiments the inner unit 18 consists of a sensing unit 19, comprising a cap 20 connected to a top plate 26, which is operationally integrated with a bottom plate 28, load cell 30 and spacer 32 so as to move the top plate 26 relative to the fixed or relatively stationary bottom plate 28, thereby applying pressure to the load cell 30. In some exemplary embodiments, a spacer 32 separates the top plate 26, bottom plate 28 and/or load cell 30. In some embodiments, a stopper 34 can be utilized to provide overload protection. FIG. 2B depicts a nut and bolt assembly 39 which can be used in certain embodiments to suspend the inner unit 18 and cap 20 within the housing 16, as is depicted in FIG. 2C. Other embodiments are possible.

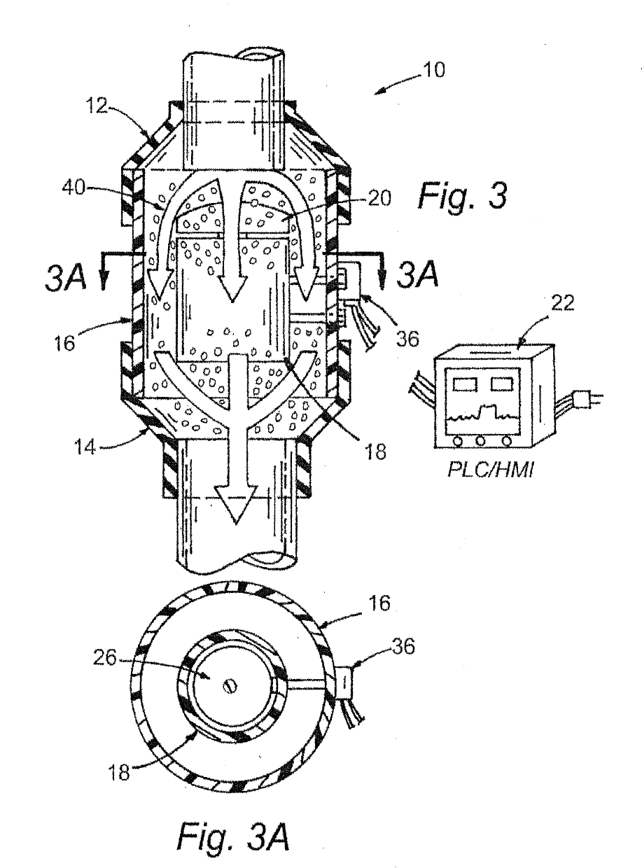

FIGS. 3-3A illustrate an example of exemplary embodiments of the flow meter in operation. In operation, a material 40 is being passed through the flow meter 10 by way of gravity or some other force. While gravity is used in this particular embodiment, other forces or pressures can also be used to pass the material over the cap 20. The material 40 is passed over the inner unit 18, particularly the flow cap 20, so as to depress the flow cap 20 relative to the bottom plate (not shown) and thereby translate the pressure into a readable signal by way of the load cell, for transmittal to the processing unit. The rounded cap 20 allows the flowable material to pass over it in layers, rather than by impact, such that, for example, a top, middle, and lower layer can be formed, with the top layer moving most quickly and the lower layer moving most slowly. For example, if the material is corn, certain implementations of the flow meter allow for layers of corn to be passing over the cap simultaneously, so as to provide a cushion and reduce the overall impact damage, such as seed splitting or breaking. Because of this layering, the flow meter can measure product-to-product contact, rather than only product-to-surface contact. This presents an improvement in the art over the prior methods involving getting rid of the seed or other material by impact and impingement. FIG. 3A shows a cross-section of a certain embodiment of exemplary embodiments from a top view, thereby illustrating the means by which the inner unit 18 is connected to the outer tube 16 by way of a connection 36. As one of skill in the art would readily recognize, many possible structures could serve as a connection.

Thus, the material entering the flow meter 10 flows over a sensing cap 20 so as to apply pressure on the cap corresponding to the weight of the material is measured with a load cell 30 arrangement underneath the sensing cap 20 for real-time analysis of the weight. The vertical gap between the inlet and sensing cap is such so that the layers of the material on the sensing cap keep moving downward freely by gravity, and reduces the material impacting the sensing surface, as is seen in the prior art. The electronic signal from the load cell arrangement is further amplified, processed, and converted to the desired unit of measure.

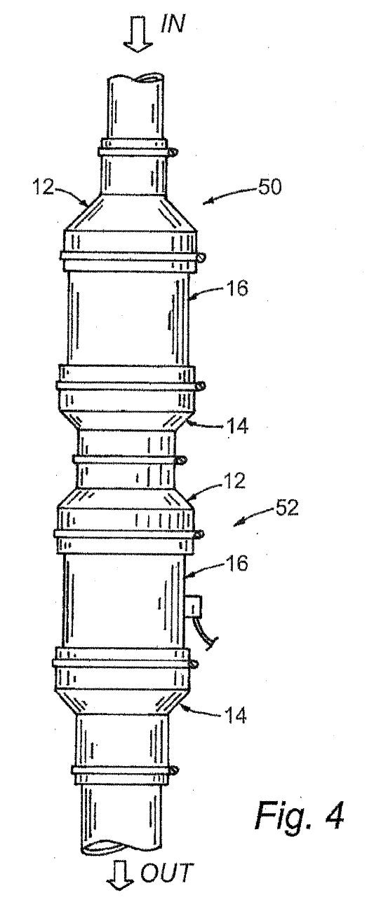

As best shown in FIG. 4, in certain embodiments, a plurality of flow meters may be set in sequence. In these embodiments, for example, a first flow meter 50 can be provided without the load cell and sensor, so as to be used, for example, as a flow regulator prior to the flowable material entering a second flow meter 52. Again, in this example, each flow meter 50, 52 consists of corresponding top 12 and bottom 14 beveled outer regions and an outer tube 16. Further embodiments of the flow regulation are discussed in relation to FIGS. 6-8.

FIG. 5 shows another exemplary embodiment of flow meter, wherein the flow meter 10 consists of corresponding top 12 and bottom 14 beveled outer regions and an outer tube 16, along with an inner unit 18 topped by a sensing cap 20. In this embodiment, the flow meter 10 also comprises an adjustment mechanism 60 which allows the adjustment of the overall distance 60A, 60B between the cap 20 and the flowable material inlet 62. In certain embodiments, the adjustment mechanism 60 allows the flow meter to be customized—either manually or based on feedback from the PLC, HMI or other processing unit (not shown)—so as to adjust the flow rate and handling of the flowable material, to improve sensitivity, reduce noise, improve efficiency, and the like. As shown in FIG. 5A, certain embodiments of the flow meter can also include a decoder 70 and stepping motor 72, operationally coupled to the adjustment mechanism 60 by way of a screw or other adjustment means 80, so as to regulate the overall distance 60A, 60B. Further, a flow readout 74 can be provided in certain embodiments, including, for example, the actual flow 76 and set flowrate 78.

FIGS. 6-8 disclose alternate exemplary embodiments of the flow regulation system also described in reference to FIG. 4. In these embodiments generally, a flow regulation unit 100 is mounted in the path of a flowing material, for example above a flow meter, 10 though the presence of such a flow meter 10 is not essential for function of the flow regulator 100. Users may desire the regulation of flow of the flowable material without requiring the use of the flow meter for those applications as an improvement over prior art methods such as the “dead box,” “cushion box” or “end box,” as in many applications of flowable, granular material, the angle of flow must be relatively steep in order to promote flow, which can result in a high rate of travel of the flowable material through a column. The introduction of the present flow regulator addresses this by regulating the speed and rate of flow at some mid-point along the fall.

In certain applications, this embodiment can be used in a situation where a flowable material such as seed is falling from a large distance or otherwise travelling at a high speed off of a conveyor or the like. In these embodiments, the flow regulator can be utilized to slow the rate of flow and/or speed, thereby reducing damage and causing the product to flow uniformly to the next step in operation. Further, in these embodiments, the damage to the flowable material can be reduced. In certain exemplary embodiments, the diameter of the bowl is such that the spacing between the bowl and the housing allows the desired flow capacity without resulting in plugging up the flow.

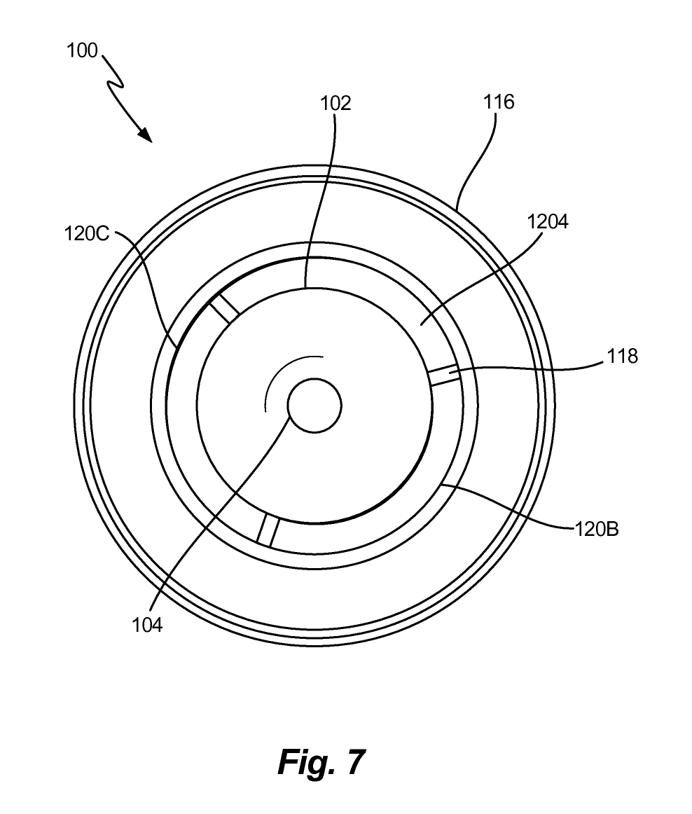

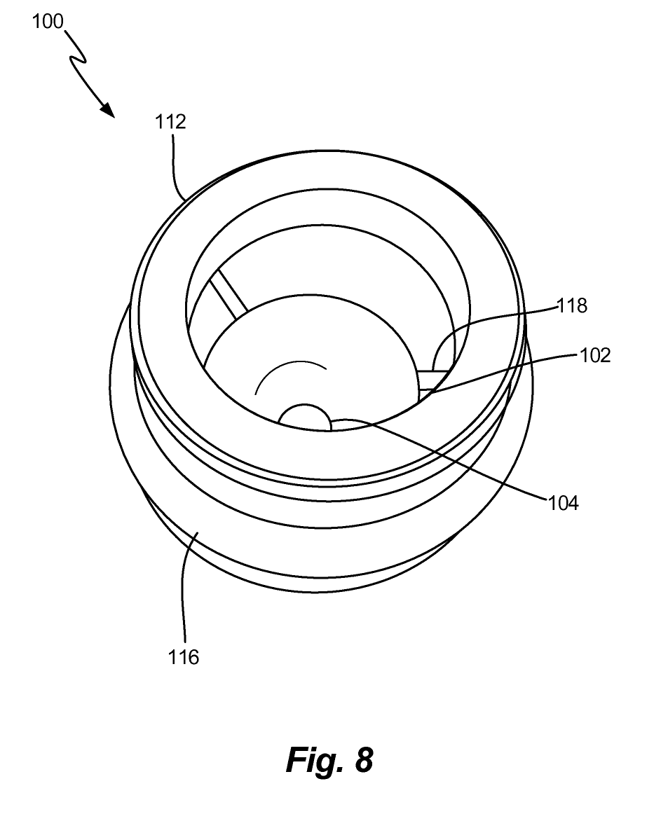

In certain alternate embodiments, rather than utilizing the rounded cap discussed elsewhere herein (such as at 20 in FIG. 1B), the flow regulator 100 comprises regulation portion such as a frustoconical portion such as an inverted dome, or otherwise funneling region 102 (hereinafter also called a “bowl”) may be utilized, as is best shown in FIGS. 7-8. In these alternative embodiments, the bowl may further comprise at least one opening or apature 104 to receive the flowable material and regulate the flow. In certain of these embodiments, the aperture can be adjustable, such as by dilation, so as to further regulate the flow through that regulator. In further of these exemplary embodiments, the frustoconical portion 102 is suspended between the corresponding top 112 and bottom 114 beveled outer regions and the larger-diameter outer tube 116 (as is shown in FIG. 6) by a plurality of supports 118, so as to accommodate flow through the opening 104.

In these embodiments, the flowable material enters the flow regulator 100 from above, such that it is able to collect in the bowl 102 and collecting there before flowing through the opening 104 and exiting the column. As such, when the size of the opening 104 is adjusted appropriately, the flowable material will tend to “pool” in the bowl, such that the impact of the individual grains, seeds, or the like is upon one another, rather than harder materials. As such, damage to the material can be reduced. In certain exemplary embodiments, the diameter of the opening may be adjustable, as by means well known in the art for adjusting the diameter of an opening or aperture, as is known in the art.

Further, in use, the material may be flowing into the bowl at a variable rate, such that the bowl may have a variable amount of material over time. In certain situations, the bowl is also configured to allow for “overflows,” so as to further provent clogging while maintaining the slowing effect of the flow regulator.

In these embodiments, this “overflow” may cause the material to slow down and/or uniformly fall out of the bowl, for example to the flow unit below (as shown in FIG. 6) by way of openings 120A, 120B, 120C between the frustoconical region 102 and the outer tube 116, thus yielding improved measurement accuracy. As the material comes in contact with other material, rather than metal or other rigid material, the flow regulator also causes less damage to the individual units of the material, and when the rate of flow reduces, the bowl 102 can continue to function as previously described.

A principle aim for the utilization of this frustoconical shape is so as to optimize the size of the opening 104 or openings. Otherwise, the material may flow out of the bowl too quickly and the bowl will not fill properly. Likewise, the opening cannot be too small, thus causing plugging of the opening by the material. Thus, in certain embodiments, the size of the opening may be adjustable.

In certain further embodiments, the frustoconical embodiments of the flow regulator can be used independently from the flow meter, wherein the flowable material is falling from a great height, or traveling at a high speed such as coming off of a conveyor, so as to provide similar reduction in damage to the flowable material and control of the flow rate.

Exemplary embodiments of the described devices, systems and methods also provide other advantages, such as being dust-free, quieter in operation, lighter, durable, causing less impact damage to the flow-through material, and fully backwards compatible or otherwise retrofittable with existing systems.

While multiple embodiments are disclosed, still other embodiments of exemplary embodiments will become apparent to those skilled in the art from the following detailed description, which shows and describes illustrative embodiments of the invention. As will be realized, the invention is capable of modifications in various obvious aspects, all without departing from the spirit and scope of exemplary embodiments. Accordingly, the drawings and detailed description are to be regarded as illustrative in nature and not restrictive.

Although exemplary embodiments has been described with reference to preferred embodiments, persons skilled in the art will recognize that changes may be made in form and detail without departing from the spirit and scope of the invention.

I claim:

1. A flow regulator for controlling the flow of a flowable material, comprising:
a. a first housing having an inlet for receiving material and an outlet for exiting material;
b. at least one support member; and
c. a regulation portion having a top side and a bottom side, wherein the regulation portion suspended in the path of the flowable material by way of the at least one support member, the regulation portion configured to control the rate of material flow.

2. The flow regulator of claim 1, wherein the top side of the regulation portion is substantially circular.

3. The flow regulator of claim 2, wherein the top side of the regulation portion is substantially domed.

4. The flow regular of claim 2, wherein the regulation portion is substantially frustoconical.

5. The flow regulator of claim 4, further comprising an opening in the regulation portion.

6. The flow regulator of claim 5, wherein the size of the opening is adjustable.

7. The flow regulator of claim 5, wherein the flow regulator is configured to allow the collection of seed within the frustoconical portion.

8. The flow regulator of claim 7, further comprising an opening between the edges of the generally circular regulation portion and the housing, wherein the flow regulator is configured to allow overflows through the opening when the frustoconical portion becomes full.

9. The flow regulator of claim 8, further comprising:
a. a second housing having an inlet for receiving material from the flow regulator and an outlet for exiting material from the second housing;
b. a sensing unit within the second housing, further comprising a rounded cap in mechanical communication with a load cell; and
c. a processor, wherein the sensing unit is in communication with the processor so as to measure the weight and flow of material passed through the second housing by measuring the pressure of the material on the rounded cap.

10. A flow regulator for measuring and controlling the rate of flow of a flowable material, comprising:
a. a flow meter assembly, further comprising:
i. a first housing having an inlet for receiving material and an outlet for exiting material;
ii. a sensing unit within the first housing, further comprising a rounded cap in mechanical communication with a load cell; and
iii. a processor, wherein the sensing unit is in communication with the processor so as to measure the flow of material passed through the housing by measuring the pressure of the material on the rounded cap; and
b. a flow regulator, further comprising:
i. a second housing having an inlet for receiving material and an outlet for exiting material; and
ii. a regulation portion suspended within the second housing.

11. The flow regulator of claim 10, wherein the top side of the regulation portion is substantially circular.

12. The flow regulator of claim 11, wherein the top side of the regulation portion is substantially domed.

13. The flow regular of claim 11, wherein the regulation portion is substantially frustoconical.

14. The flow regulator of claim 13, further comprising an opening in the regulation portion.

15. The flow regulator of claim 14, wherein the size of the opening is adjustable.

16. The flow regulator of claim 14, wherein the flow regulator is configured to allow the collection of seed within the frustoconical portion.

17. The flow regulator of claim 16, wherein the flow regulator is placed above the flow meter assembly so as to assist in the regulation of the flow rate.

18. A system for regulating the flow of a flowable material, the system comprising:
a. a flow regulator for controlling the flow of a flowable material, further comprising:
i. a first housing having an inlet for receiving material and an outlet for exiting material;
ii. at least one support member; and
iii. a regulation portion having a top side and a bottom side, wherein the regulation portion suspended in the path of the flowable material by way of the at least one support member, the regulation portion configured to control the rate of material flow;

19. The flow regulator of claim 1, wherein the regulation portion further comprises an opening and the top side of the regulation portion is substantially frustoconical, wherein the flow regulator is configured to allow the collection of seed within the frustoconical portion.
